(19) United States
(12) Patent Application Publication
(10) Pub. No.: US 2016/0092816 A1
(43) Pub. Date: Mar. 31, 2016

(54) INTELLIGENT BUFFER REDUCTION AND BALANCING TO MORE EFFICIENTLY USE AVAILABLE RESOURCES AND PERCEIVE POTENTIAL SAVINGS

(71) Applicants: Sylvia Beate Wuertele, Sandhausen (DE); Matthias Buehl, Heidelberg (DE)

(72) Inventors: Sylvia Beate Wuertele, Sandhausen (DE); Matthias Buehl, Heidelberg (DE)

(21) Appl. No.: 14/497,039

(22) Filed: Sep. 25, 2014

(51) Int. Cl. G06Q 10/06

(52) U.S. Cl. CPC G06Q 10/06315

(57) ABSTRACT

The present disclosure describes methods, systems, and computer program products for providing services for efficient use of existing resources. One computer-implemented method includes building a data model enhanced for efficient storage of a material, the enhancements permitting generation of optimization problem solutions related to storage of the material, wherein the enhancements include technical specifications and customizing data, enhancing one or more attributes of the enhanced data model with regulatory attributes or rules, performing, using the enhanced data model, demand planning related to the material, performing, using a dynamic optimization algorithm, material transfer planning to determine where to most effectively store the material, performing a simulation of various storage possibilities of the material, and balancing amounts of the material using results of the performed simulation by shifting quantities of the material to, from, or within a particular storage medium.

### BACKGROUND

Given an increasingly fierce competitive environment, for example in business, it is more and more important to use (e.g., store, purchase, etc.) existing resources (e.g., raw materials, energy, storage space, money, produced goods, etc.) more efficiently and to perceive potential savings in their use. Determining optimal resource quantity distribution within given restrictions and maximizing profit and/or minimizing costs through balanced storage usage with optimized buffers are keys to business success. Poor determination of resource quantity distribution and inefficient resource storage practices, including inefficient buffering, increases costs of doing business and a total cost of ownership for the various resources.

### SUMMARY

The present disclosure relates to computer-implemented methods, computer-readable media, and computer systems for providing services for efficient use of existing resources. One computer-implemented method includes, as a first implementation, building a data model enhanced for efficient storage of a material, the enhancements permitting generation of optimization problem solutions related to storage of the material, wherein the enhancements include technical specifications and customizing data, enhancing one or more attributes of the enhanced data model with regulatory attributes or rules, performing, using the enhanced data model, demand planning related to the material, performing, using a dynamic optimization algorithm, material transfer planning to determine where to most effectively store the material, performing a simulation of various storage possibilities of the material, and balancing amounts of the material using results of the performed simulation by shifting quantities of the material to, from, or within a particular storage medium.

A second computer-implemented method, as a second implementation, includes building a data model enhanced for efficient storage of a material by dynamically or statically expanding storage of the material in combined various storage mediums as a pooled storage, wherein the enhancements include technical specifications and customizing data, performing, using the enhanced data model, demand planning related to the material, performing, using a dynamic optimization algorithm, material transfer planning to determine where to most effectively store the material into the pooled storage, the pooled storage including a plurality of storage mediums of the various storage mediums, performing a simulation of various pooled storage possibilities for the material, determining a pool landscape of the pooled storage based on results of the performing of the simulation, and balancing amounts of the material using results of the performed simulation by shifting quantities of the material to, from, or within storage mediums of the various storage medium associated with the pooled storage of the determined pool landscape.

Other implementations of this aspect include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The first implementation can optionally include one or more of the following features, alone or in combination:

A first aspect, combinable with the general implementation, wherein the technical specifications include attributes of the material relevant for storage of the material, the technical attributes including attributes and boundary conditions associated with the particular storage medium to store the material, and customizing data includes business-oriented managerial attributes and boundary conditions for the particular storage medium.

A second aspect, combinable with any of the previous aspects, wherein demand planning includes at least one of determining what material is planned to be stored, for what period of time, in what kind of storage media, at what maximum costs, or where the material is located.

A third aspect, combinable with any of the previous aspects, further comprising factoring-in risk opportunity considerations, including at least one of resources that might not be available when needed, insufficient buffer sizes, losses occurring through surplus, or an oversized buffer.

A fourth aspect, combinable with any of the previous aspects, wherein the balancing includes determining the optimal maximum fill level for the particular storage medium.

The second implementation can optionally include one or more of the following features, alone or in combination:

A first aspect, combinable with any of the previous aspects, wherein the technical specifications include attributes of the material relevant for storage of the material, the technical attributes including attributes and boundary conditions associated with the particular storage medium to store the material including attributes particular to each storage medium of the particular storage medium that is part of a pooled storage, and customizing data includes business-oriented managerial attributes and boundary conditions for the particular storage medium.

A second aspect, combinable with any of the previous aspects, wherein demand planning includes at least one of determining what material is planned to be stored, for what period of time, in what kind of storage medium, at what maximum costs, or where the material is located.

A third aspect, combinable with any of the previous aspects, further comprising instructions to factor-in risk opportunity considerations, including at least one of resources that might not be available when needed, insufficient buffer sizes, losses occurring through surplus, or an oversized buffer.

A fourth aspect, combinable with any of the previous aspects, wherein the balancing includes determining the optimal maximum fill level for the various storage mediums associated with the pooled storage of the determined pool landscape.

The subject matter described in this specification can be implemented in particular implementations so as to realize one or more of the following advantages: First, existing resources are used more efficiently. Second, potential savings can be perceived and quantified. Third, costly and unnecessary storage buffering of resources can be minimized since buffering needs can be determined with greater precision due to the ability to find an optimal quantity distribution within given restrictions. Fourth, profit related to stored resources can be maximized and/or costs can be minimized through a balances storage usage with optimized buffers. Fifth, existing resources can be stored more efficiently through the use of pooled storage. Other advantages will be apparent to those of ordinary skill in the art.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a flow chart illustrating a method for providing services for efficient storage of existing resources according to an implementation.

FIG. 2A is block diagram illustrating a single storage for storing a material according to an implementation.

FIG. 2B is a block diagram illustrating a pooled storage according to an implementation.

FIG. 2C is a block diagram illustrating the use of a distributor to control multiple pools according to an implementation

FIG. 3 is a flow chart illustrating a special method for providing services for efficient storage of existing resources by combining various storage media into a pool according to an implementation.

FIG. 4 is a block diagram illustrating relationships between actors in an example smart portfolio management energy scenario according to an implementation.

FIG. 5 is a high-level block diagram of an example distributed computing system (EDCS) for providing the above-described services related to FIGS. 1, 2A, 2B, 2C, 3, and 4 according to an implementation.

Like reference numbers and designations in the various drawings indicate like elements.

### DETAILED DESCRIPTION

This disclosure generally describes computer-implemented methods, computer-program products, and systems for providing services for efficient use of existing resources. The following description is presented to enable any person skilled in the art to make and use the invention, and is provided in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described and/or illustrated implementations, but is to be accorded the widest scope consistent with the principles and features disclosed herein.

Given an increasingly fierce competitive environment, for example in business, it is more and more important to use (e.g., store, purchase, etc.) existing resources (e.g., raw materials, energy, storage space, money, produced goods, etc.) more efficiently and to perceive potential savings in their use. Determining optimal resource quantity distribution within given restrictions and maximizing profit and/or minimizing costs through balanced storage usage with optimized buffers are keys to business success and involve solving one or more optimization problems using one or more optimization methods, including those that are known, commercially available, and/or proprietary. Poor determination of resource quantity distribution and inefficient resource storage practices, including inefficient buffering, increases costs of doing business and a total cost of ownership for the various resources.

The following disclosure describes in detail three optimization problems and computer-implemented methods, computer-program products, and systems for providing solutions. The three optimization problems are smart balancing, smart pooling, and smart portfolio management.

For the purposes of this disclosure, “conversion of resources” and “conversion” typically mean the changing of a substance from one state to another. Generally, conversion result in the same “amount” of a new substance, but the new substance is in a different state, form, etc. Note that conversion of resources is not always necessary or even possible in specific case. In some cases, however, conversion of resources can be necessary. For example, sunlight can be collected by solar energy conversion station as heat and converted to electricity (conversion of sunlight to heat and then to electricity), then the electricity can be transmitted and stored in a battery for later use (conversion of electricity into chemical energy). In another example, water can be pumped underground into geothermal areas to heat the water for use in generating electricity. Water can also be pumped up a hill, stored, and allowed to run down the hill under the influence of gravity to generate electricity with a hydroelectric turbine (conversion of water into electricity). Another example related to finance can be the exchange/conversion of Euros into Dollars.

Note that for each conversion, there is typically a cost (e.g. fees, rounding errors when converting financial instruments, etc.). The cost must be kept in mind when conversion takes place as it introduces a loss factor.

Smart Balance

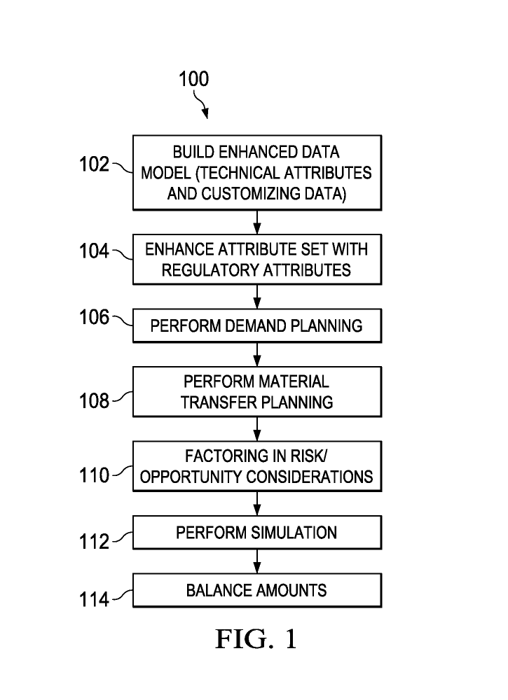

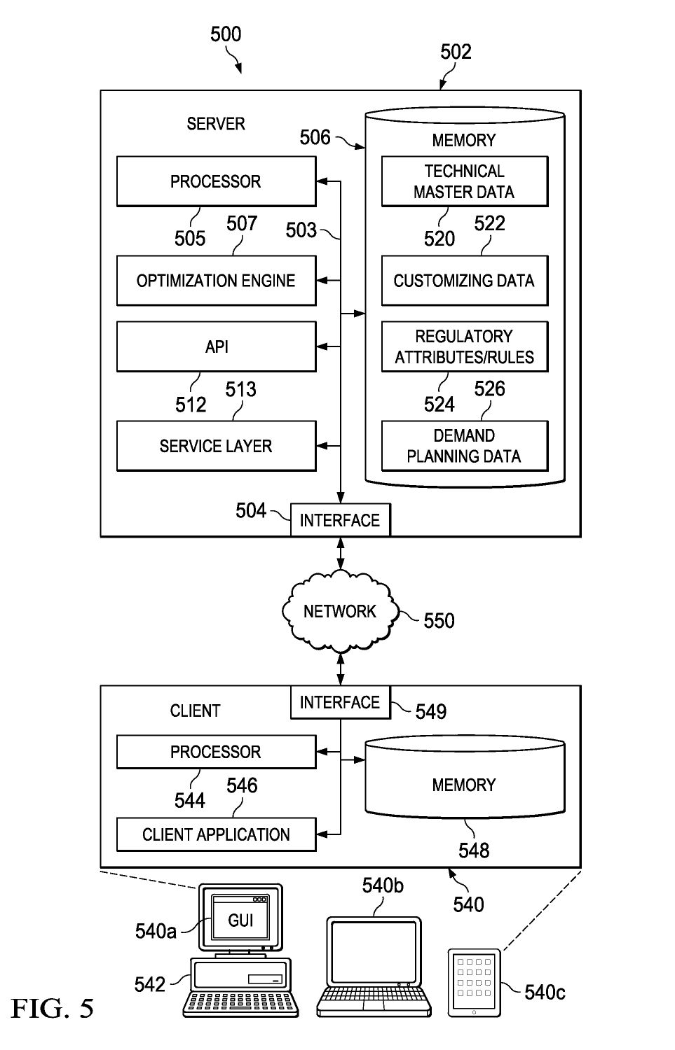

FIG. 1 is a flow chart illustrating a method 100 for providing services for efficient storage of existing resources according to an implementation. For clarity of presentation, the description that follows generally describes method 100 in the context of FIGS. 1 and 5. However, it will be understood that method 100 may be performed, for example, by any other suitable system, environment, software, and hardware, or a combination of systems, environments, software, and hardware as appropriate. In some implementations, various steps of method 100 can be run in parallel, in combination, in loops, or in any order.

For the purposes of this disclosure, the terms “material” and “material quantity” are considered independent of a specific name for a given resource type (e.g., raw materials, energy, storage space, money, produced goods, etc.). To provide information regarding efficient use of existing resources, a primary challenge is to balance a quantity of a material regarding its storage and storage price (to optimize) and to find an optimal band of options associated with at least storage and/or storage price. Boundary conditions can arise from at least material properties (e.g., volatility—tendency to evaporate/mix/contaminate, etc., solids vs. liquids, potable vs. non-potable liquids such as milk and oil, etc.), storage requirements (e.g., some materials need a particular storage environment—temperature, pressure, materials to contain, etc.), and/or a storage environment (e.g., geographic location, environment, etc.). The overall goal is to plan where to store a material most effectively (e.g., where the material fits best—in a single storage or pooling). As noted below, in some instance, it is possible to have a negative balance for certain non-tangible material (e.g., money, credit, etc.).

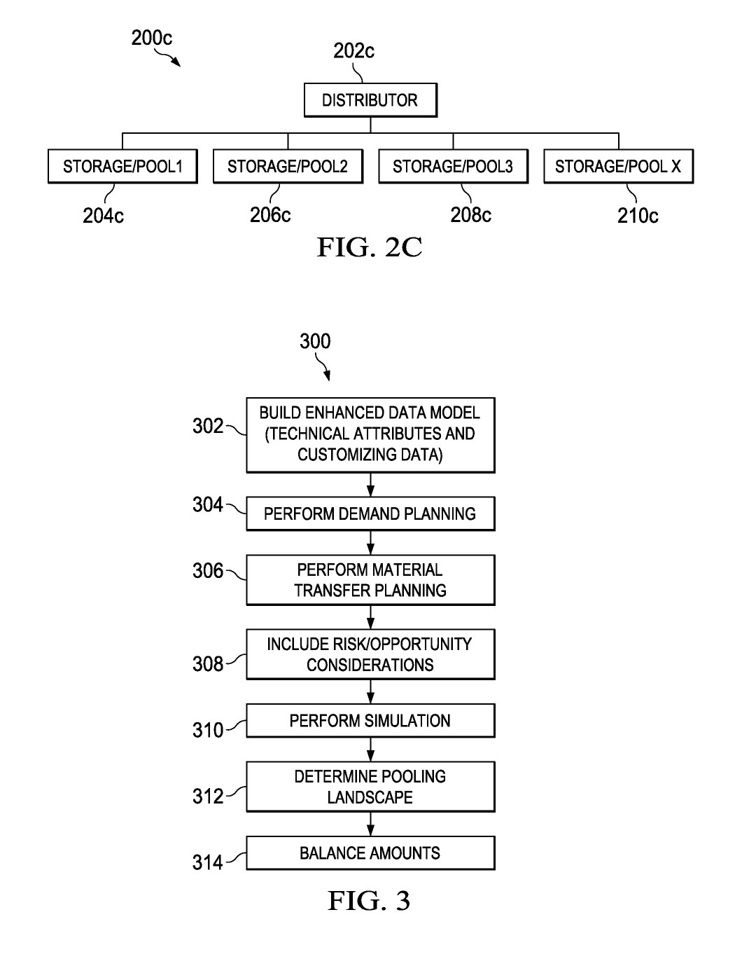

At 102, an enhanced data model is built. In some implementations, a data model associated with, for example, storage of resources, is enhanced with and includes technical specifications and customizing data (see 522 in FIG. 5). In some implementations, the technical specifications are not modifiable while the customizing data is modifiable (e.g., can change over time due to, for example, external circumstances). The enhanced data model and associated data is a key element of the computer-implemented methods, computer-program products, and systems for providing solutions to the associated optimization problems. The enhanced data model provides data that is operated on by the optimization engine(s) (see FIG. 3 and associated description for additional detail)

In some implementations, technical specifications can include material attributes (master data) and technical attributes for a storage media (technical master data) (see 520 in FIG. 5). Material attributes typically include attributes (description) of the material (e.g., solid, liquid, gas, reactivity to other materials, required storage temperature/pressure, etc.) that is relevant for storage of the material, including any necessary or possible transformations (e.g., storing electricity in water storage, cash in shares, etc.) and a diffusion coefficient (e.g., materials can shrink/reduce in quantity/value/potency, fluids/solids can evaporate/sublime, etc.). As an example related to money: an amount of cash for a specific deposit increases the amount of money depending on the interest rate which is paid for the deposit type, but the total value of the money can be decreased by an inflation rate so that a diffusion coefficient for money related to that specific deposit is calculated as the interest rate minus an inflation rate. Technical master data includes relevant technical attributes and technical boundary conditions associated with a particular storage media (e.g., storage capacity, minimum fill level, optimal fill level, maximum fill level, whether the storage is for standalone or poolable storage, whether a material mix is possible or not possible (e.g., two different liquids such as water and milk could mix and should not be stored together but red and green boxes could be stored in the same warehouse), and/or other attributes/boundary conditions consistent with this disclosure. Note that in some instances, consecutive usages of storages may be necessary. For example, a tank used to store a toxic chemical, petroleum, etc. cannot then be used for storing milk or water. In some implementations, the fact that storing a particular type of material in the tank will preclude the storage of another type of material must be taken into account.

Customizing data (see FIG. 5, 522) belongs to the enhanced data model 102 and is business-oriented attributes/boundary conditions which, in typical implementations, can be modified. With customization, boundary conditions can be defined. In some implementations, customizing data includes managerial attributes for the storage media (managerial master data), operational attributes for the storage media (operational master data) and/or attributes for the transfer of material from a first storage to a second storage (transfer attributes). In some implementations, managerial master data includes relevant managerial attributes and managerial boundary condition for the storage media (e.g., economic minimum fill level, economic optimal fill level, economic maximum fill level, and/or availability). Managerial master data is used to try to optimize from an economic standpoint a minimization of cost as well as risk. In some implementations, operational master data includes relevant operational attributes and operational boundary conditions for the storage media (e.g., short-, mid-, long-term availability, time pattern, opening hours, minimum/optimum/maximum holding/storage period such as 24×7 or 24/7/365, and/or set-up costs, etc.). In some implementations, transfer attributes can include relevant operational attributes for the transfer of material from a first storage to a second storage, with or without a transformation of the material (e.g., storing electricity in water, electricity in batteries, cleaning costs, etc.). In the case of a transformation, transformation costs may be a factor. Transaction, removal, cleaning, transportation (e.g., hazardous material and material encasement/safety precautions) and/or other fees can also be a factor with respect to transfer attributes.

In some implementations, other data (even if not explicitly described) that is consistent with this disclosure can be made part of the enhanced data model. From 102, method 100 proceeds to 104.

At 104, one or more attributes of the enhanced data model are enhanced with regulatory attributes/rules (see 524 in FIG. 5). For example, the regulatory attributes/rules can include CO2 emission (i.e., a “carbon footprint”), risk class (e.g., explosive fluids/solids, radioactive substances, biological substances, money—bonds are a lower risk than foreign stock purchases, etc.), importation/exportation requirements, regulatory requirements/limitations, and/or other regulatory attributes. From 104, method 100 proceeds to 106.

At 106, demand planning is performed. For example, transactional data and advice can become a factor in demand planning and incorporated into demand planning data (see 526 in FIG. 5). Demand planning can also include, for example, determining what material is planned to be stored, for what period of time, in what kind of storage, at what maximum costs, and/or where the material comes from/is currently located (e.g., material and material quantity, storage period (investment horizon), maximum allowed storage costs (to determine whether it is possibly cheaper to dispose of the material rather than store), current location, etc.). From 106, method 100 proceeds to 108.

At 108, material transfer (transaction data) planning is performed. Here a plan is generated as to where to store material most effectively. In some implementations, this includes determining available storages and distinguishing which is a best “fit” for the material(s) in questions. The planning can also include differentiation between single storage and pooling storage locations, necessary material conversion and transfer costs. Note that within a pool, there are typically no additional transfer costs (or at least lower rates for transfer costs). Attributes defining a pool specified, particular defining material transfer criteria, parameters, etc. The attributes defining the pool are incorporated into technical master data (see 520 in FIG. 5) and the customizing data (see 522 in FIG. 5).

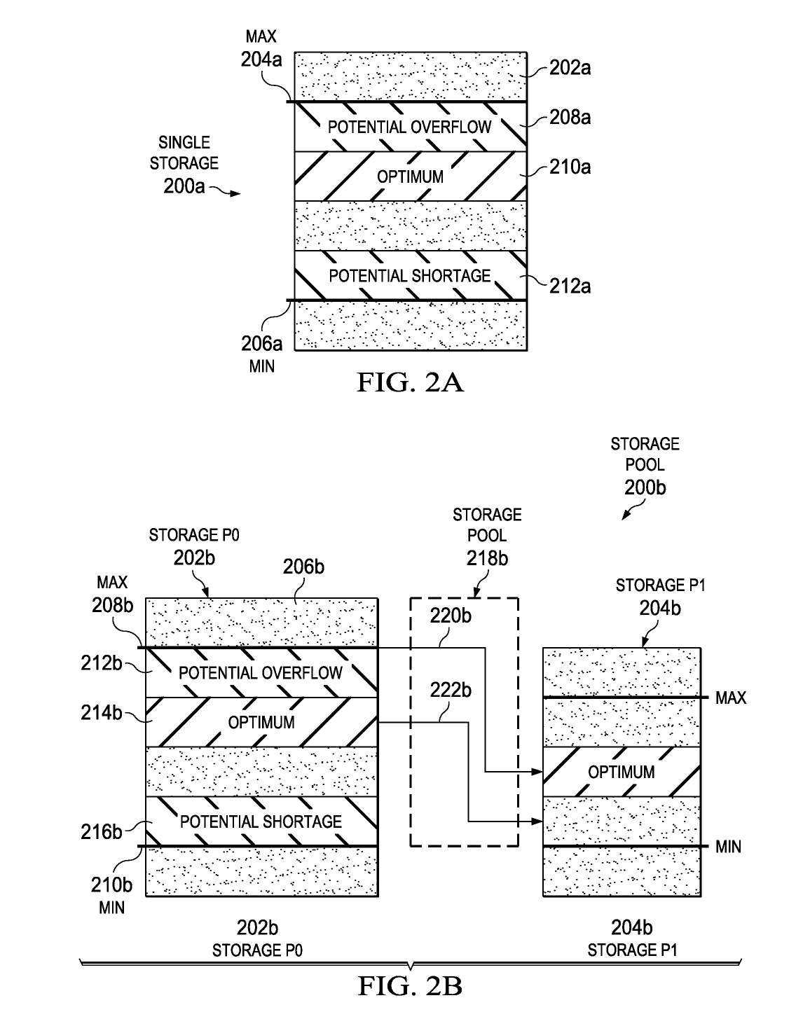

Referring now to FIGS. 2A and 2B, FIG. 2A is block diagram illustrating a single storage 200a for storing a specific material 202a (e.g., grain, water, oil, chemicals, etc.). The single storage 200a is typically treated as a black box. With respect to the single storage 200a, there is an entry and exit point (not illustrated) for material to enter/exit the single storage, respectively. There is also a minimum fill level 206a, an optimum fill level 210a, a maximum fill level 204a, and an aspirational fill level (not illustrated that describes a desired fill level that may or may not be attainable. For example, a 16 GB USB flash drive can only be filled to approximately 15.2 GB due to known storage conversion issues—considering a single MB of computer storage as 1000 Bytes as opposed to 1024 Bytes). For the purposes of a transfer, a pool is treated as a single storage. For example, the single storage could be a pool made up of multiple storages but from a high-level, the pool can be treated as a single storage by other single storages/pools. The makeup of a storage/pool, contents, etc. is handled by smart pooling functionality (described below) to optimize the storage, transfer, etc. of the material.

The single storage 200a can be given a particular name. The maximum capacity 204a represents how much can actually be stored in the single storage 200a. For example, the memory storage example above, or air at the top of barrels or storage tanks, etc. Note that a maximum fill level 204a and the minimum fill level 206a can be single values or ranges of values. In FIGS. 2A (and 2B) the maximum fill level 204a and the minimum fill level 206a are ranges for single storage 200a in FIG. 2A and storage P0 in FIG. 2B. Note that Storage P1 204b in FIG. 2B has distinct maximum/minimum fill levels. Ranges permit rules to generate alerts when values fall within particular values in ranges. For example, if 90% full falls within potential overflow 208a, rules can be used to generate an alert that an overflow situation is occurring with single storage 200a and trigger actions to prevent an overflow situation to occur. The ranges can be treated as a buffer zone to allow actions before a maximum or minimum value is reached and/or exceeded.

FIG. 2B is a block diagram illustrating a pooled storage 200b according to an implementation. Pooled storage 200b is typically made up of at least two or more storages (e.g., storage P0 202b and storage P1 204b for storing a material 206b). Each storage in a pool initially behaves like a single storage in that it has its own credentials, rules when filled, open, etc. (e.g., some storages may not be available at every point in time—such as a bank). With respect to the pooled storage 200b, storage P1 204b provides a “buffer” for Storage P0 202b to help prevent underflow or overflow. Note that the opposite can also be true (e.g., Storage P0 202b can act as a buffer for Storage P1 204b).

In some implementations, one or more mechanisms, systems, etc. (e.g., a “distributor” 218b implementing a distribution method, algorithm, and/or rules) can provide, at a high level, functionality to automatically shift material between storages P0 202b/P1 204b in an optimized manner. For example, distribution rules can be used when a potential overflow situation exists within the pool. In other situations, a material can be shifted into the pool from a position external to the pool or shifted from a pool's interior to a position external to the pool (e.g., rebalancing money between different accounts, banks, etc.).

Note that in FIGS. 2A and 2B, the storages can contain defined maximum (e.g., in FIG. 2A 204a) and minimum (e.g., in FIG. 2A 206a) storage levels and the overflow and shortage considerations as illustrated can be lacking—similar to single storage 204b in storage pool 200b of FIG. 2B.

Referring to FIG. 2C, FIG. 2C is a block diagram 200c illustrating the use of a distributor 202c to control storage in multiple storages/pools 204c, 204c, 208c, 210c according to an implementation. A strategy or strategies are typically defined with respect to buffering and/or when moving material from one storage to another in a pool, or with single storages. There is a set of rules (as mentioned above with respect to FIG. 2A) describing what action to perform based on an action. The rules can trigger actions based on conditions. Triggers can be configured depending on the above-mentioned strategy or strategies. For example, for a particular storage is not more expensive than another or is much less expensive than another, the strategy/action will be to keep most material in that storage as opposed to moving it to a more costly storage. In urgent cases, material can be moved from the particular storage, but only if necessary and only the minimum amount necessary. The distributor 202c (or 218b in FIG. 2B) can control these actions, flow rate, material type, material transfer amount, timing, etc.

Referring back to FIG. 2B, the two arrows in 218b represent two different strategies that can be implemented/controlled by the distributor 218b. For example, each arrow can represent a way to optimize on a different storage (either P0 or P1). The upper arrow 220b can represent a strategy for when storage P0 202b is in an overflow state, material is converted/transferred to storage P1 204b. The bottom arrow 222b can represent a strategy to keep the storage level in storage P0 202b in the optimum range 214b. If storage P0 202b moves out of the optimum range, material can be converted/transferred to or converted/pulled from storage P1 204b.

Ranking of storages is also possible. For example, some storages are higher ranked for specific purposes. A financial example would include considerations as to where to store money. It can be stored in a day-to-day cash account storage with very low interest but easy withdrawal requirements or an account with high interest that locks the funds for a specified time frame (e.g., 30 or 90 days). In the higher-yielding account, more positive income is received, but money is unavailable without penalties. Depending on the strategy, either type of account could be ranked higher than another and optimum storages can be chosen based on the ranking (e.g., using a decision tree that takes into account ranking and/or other values). In some instances, multiple overall strategies can be determined using the decision trees.

Returning to FIG. 1, in some implementations, the material transfer planning is performed using a dynamic optimization method/algorithm (e.g., performed by the optimization engine 307 in FIG. 3). In some implementations, the dynamic optimization can consider decision problems as a consequence of interdependent individual decisions which are solved sequentially. From 108, method 100 proceeds to 110.

At 110, risk/opportunity considerations can be factored. In some implementations, risk/opportunity considerations can include that: 1) resources might not be available when needed; 2) buffer size(s) may not be not sufficient; 3) losses occurring through surplus; and/or 4) a buffer size can be too big. In other implementations, other risk/opportunity considerations consistent with this disclosure can be considered. From 110, method 100 proceeds to 112.

At 112, a simulation can be performed. Once external/internal factors and all boundary conditions and requirements are collected in the system, various possibilities and its flows can be simulated, e.g.,: 1) expected inflows; 2) expected outflows; 3) filling levels; 4) buffers or corrections for unexpected (e.g.; based on experiences from past (couplings); and/or 5) control mechanism(s). In some implementations, optimization methods are used to perform/work with the simulation. For example, an optimization method can: 1) consider decision problems as a result of each other dependent individual decisions; 2) perform a sequential solution of a split over several stages or periods decision-making process; and/or 3) consider then-existing decision alternatives at each stage. From 112, method 100 proceeds to 114.

At 114, balancing of amounts through shifting quantities from storage-to-storage is performed. Balancing may include data pertaining to into the system, out of the system, and/or within the system. As part of balancing, an optimal maximum fill level (and possibly onward through several levels) is determined Determining the optimal maximum fill level can include, in some implementations, data pertaining to where a resource flows to and from which level onwards does the resource flow further away? Note that transfer/balancing can take place following 108 if risk/opportunity considerations 110 and/or a simulation (e.g., 112) is not performed. In one possibility risk/opportunity considerations 110 and a simulation can be omitted. In another possibility, for example, if have distinct rules that cannot be varied as to which storage material will be moved to, a later simulation is not necessary. If a simulation is possible/necessary (e.g., handling hazardous materials), determining risk/opportunity considerations can be very important, and the result can be used to simulate different strategies for optimality during the balancing of amounts in 114. Note in some instances, that balancing amounts can also take place between 108 and 110. After 114, method 100 stops.

Smart Pooling

FIG. 3 is a flow chart illustrating a special method 300 for providing services for efficient storage of existing resources by combining various storage media into a pool according to an implementation. For clarity of presentation, the description that follows generally describes method 300 in the context of FIGS. 1-2 and 5. However, it will be understood that method 300 may be performed, for example, by any other suitable system, environment, software, and hardware, or a combination of systems, environments, software, and hardware as appropriate. In some implementations, various steps of method 300 can be run in parallel, in combination, in loops, or in any order. Note that in some implementations, one or more attributes of the enhanced data model associated with pooling can be enhanced with regulatory attributes or rules similar to 104 above.

Smart pooling is a special case of the above-described smart balancing described in FIGS. 1, 2A, 2B, and 2C and describes dynamically or statically expanding storage under inclusion of constraints to combine various storage media (e.g., containers) to a “pooled” storage. In some instances, a pool is advantageous in that a pool can be considered as a single unit, which can be used to negotiate better terms. For example, money can be pooled for a particular time period to negotiate better interest rate returns than if the money was stored in multiple smaller amounts and in different locations.

In some implementations, a pool is defined, at least in part, by answers to the following questions: 1) what is the pooling intention (e.g. cross-border pooling, cross-currency pooling, zero-balancing pool, etc.)?; 2) which storages belong to a pool?; 3) when was/is a pool set up/to be set up?; 4) when and how is the pool filled (typically a pool is supplied by multiple sources)?; 5) when and how is the material to be taken out of the pool?; 6) when and how is the material to be moved within the pool (e.g., from one container to another)? In other implementations, other questions consistent with this disclosure may be used/leveraged. In general, storage allocation and de-allocation costs and times for equipment and disarmament must be included as factors for smart pooling. Also, terms for storage availability are typically considered (e.g., temporary/permanent/seasonal storage, etc.).

At 302, the enhanced data model described above with respect to FIGS. 1 (102) and related to “Smart Balancing” is built. The enhanced data model is enhanced with attributes defining a pool. The attributes defining the pool are incorporated into the technical master data (see 520 in FIG. 5) and the customizing data (see 522 in FIG. 5).

Technical attributes for the pool are incorporated into the technical master data which remain stable and are typically not influenced or changed. The pool-related technical master data includes relevant technical attributes and technical boundary conditions for each container belonging to a pool (e.g., capacity, minimum fill level, optimal fill level, maximum fill level, material mix possible/not possible, etc.).

Customizing data is business-oriented attributes/boundary conditions which, in typical implementations, can be modified and can change over time (e.g., depending on external circumstances). With customization, boundary conditions can be defined. In some implementations, customizing data includes business attributes for the pool (business master data), operational attributes for the pool (operational master data), attributes for the transfer of material within the pool from a first storage to a second storage, and/or attributes for the transfer of material into the pool or from the pool (transfer attributes). In some implementations, business master data includes relevant business attributes and business boundary conditions for a container belonging to the pool (e.g., economic minimum fill level, economic optimal fill level, economic maximum fill level, availability, etc.). In some implementations, operational master data from “smart balancing” is further modified to contain relevant operational attributes and operational boundary conditions for a container belonging to the pool (e.g., short-, mid-, long-term availability, time pattern, opening hours, minimum/optimum/maximum holding/storage period such as 24×7 or 24/7/365, and/or set-up costs, etc.). In some implementations, the above described transfer attributes from “smart balancing” are further modified to contain relevant operational attributes for the transfer of material within the pool from container to container, without or with material transformation (e.g., storing electricity in water, electricity in batteries, etc.). In the case of a transformation, transformation costs may be a factor. Transaction, removal, transportation (e.g., hazardous material and material encasement/safety precautions) or other fees can also be a factor with respect to transfer attributes—necessary to activate or inactivate parts of a pool (e.g., cleaning of a silo/tank and/or maintenance work. In a financial context this might occur if a bank changes its risk class and an investment receives a different limit (cap) for allowed money on bank accounts due to a typically followed anti-proportional-type of function. For example, a company has a deposit at a bank which is rated as of a particular data with a AA rating. Due to the rating of the bank, the company's internal maximum is set to $300,000. Then, in the following month, the bank's rating is suddenly downgraded to BBB. The company can adopt its internal maximum to $200,000 as the risk class has increased.

In some implementations, attributes for the transfer of material into the pool or from the pool can include relevant operational attributes for the transfer of material into the pool or from the pool, without or with material transformation (e.g., storing electricity in water, electricity in batteries, etc.). In the case of a transformation, transformation costs may be a factor. Transaction, removal, transportation (e.g., hazardous material and material encasement/safety precautions) or other fees can also be a factor with respect to transfer attributes. From 302, method 100 proceeds to 304.

At 304, demand planning is performed. For example, transactional data and advice can become a factor in demand planning and incorporated into demand planning data (see 526 in FIG. 5). Demand planning can also include, for example, determining what material is planned to be stored, for what period of time, in what kind of storage, at what maximum costs, and/or where the material come from/is currently located (e.g., material and material quantity, storage period (investment horizon), maximum allowed storage costs (to determine whether it is possibly cheaper to dispose of the material rather than store), current location, etc.). Information necessary to perform synchronization, coordination, and matching is added. From 304, method 300 proceeds to 306.

At 306, material transfer (transaction data) planning is performed. Here a plan is generated as to where to store material most effectively. In some implementations, this includes determining available storages and distinguishing which is a best “fit” for the material(s) in questions. The planning includes differentiation between single storage and pooling storage locations, necessary material conversion and transfer costs. Particular data related to pooling is determined, including: 1) criteria and events when a resource is transferred into the pool; 2) when a resource is redistributed within the pool; and/or 3) when and how a resource flows out of the pool (incl. ad hoc/periodic, etc.). From 306, method 300 proceeds to 308.

At 308, risk/opportunity considerations are factored. In some implementations, risk/opportunity considerations can include that: 1) resources might not be available when needed; 2) buffer size(s) may not be not sufficient; 3) losses occurring through surplus; and/or 4) a buffer size can be too big. In other implementations, other risk/opportunity considerations consistent with this disclosure can be considered. From 308, method 300 proceeds to 310.

At 310, a simulation is performed. Once external/internal factors and all boundary conditions and requirements are collected in the system, various possibilities and its flows can be simulated, e.g.,: 1) expected inflows; 2) expected outflows; 3) filling levels; 4) buffers or corrections for unexpected (e.g.; based on experiences from past (couplings); and/or 5) control mechanism(s). In some implementations, optimization methods are used to perform/work with the simulation. For example, an optimization method can: 1) consider decision problems as a result of each other dependent individual decisions; 2) perform a sequential solution of a split over several stages or periods decision-making process; and/or 3) consider then-existing decision alternatives at each stage. From 310, method 300 proceeds to 312.

At 312, method 300 determines the pool landscape based on the simulation. For example, the determination can include: 1) one or more landscape buffers (e.g., how many accounts where?/How many storages where?); and/or 2) an optimal minimum fill level for storages. Note that typically the determination of the pooling landscape is usually a step at system set-up that is performed rarely and the determined pool landscape stays stable over a specific time frame (as described above with respect to technical attributes for the pool). From 312, method 300 proceeds to 314.

At 314, balancing of amounts through shifting quantities from storage-to-storage is performed. Balancing may include data pertaining to into the system, out of the system, and/or within the system. As part of balancing, an optimal maximum fill level (and possibly onward through several levels) is determined Determining the optimal maximum fill level can include, in some implementations, data pertaining to where a resource flows to and from which level onwards does the resource flow further away? Note that transfer/balancing can take place following 306 if risk/opportunity considerations 308 and/or a simulation (e.g., 310) is not performed. In one possibility risk/opportunity considerations 308 and a simulation can be omitted. In another possibility, for example, if have distinct rules that cannot be varied as to which storage material will be moved to, a later simulation is not necessary. If a simulation is possible/necessary (e.g., handling hazardous materials), determining risk/opportunity considerations can be very important, and the result can be used to simulate different strategies for optimality during the balancing of amounts in 314. Note in some instances, that balancing amounts can also take place between 306 and 308. After 314, method 300 stops.

Smart Portfolio Management

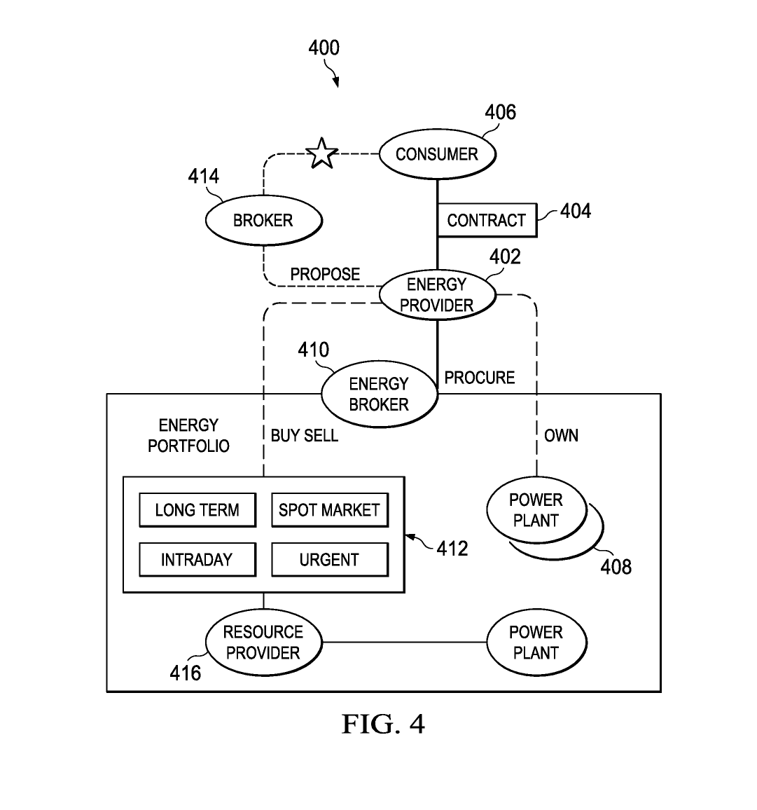

FIG. 4 is a block diagram illustrating relationships between actors in an example smart portfolio management energy scenario according to an implementation (in other implementations, other than energy can be considered instead—money, automobile fleets, etc.). Smart portfolio management refers to managing smart balance and smart pooling. For example, is a pool needed only short term or for long term? Can some existing storage that is not continuously needed be allocated for other use to maximize its value? Smart portfolio management also attempts to maximize the efficient allocation and/or distribution of balanced/pooled material. For example, where can energy most efficiently be obtained to replenish a pool or what is the most advantageous location to distribute energy from for a buyer?

Note that, as described above, in some scenarios (also related to smart balance and smart pooling as described above), a negative balance is possible for some non-tangible materials (e.g., virtual money, credit, etc.—as it is impossible to technically have negative water, oil, grain, energy, etc. as a tangible substance). Take a financial situation where a company is responsible for paying a large bill which exceeds (perhaps on a temporary basis) an overall available amount. In this situation, external resources (e.g., money) must be activated to cover any shortfall. In this case, a defined minimum fill level (e.g., 206a and/or 210b) can be exceeded resulting in a negative amount. Note that with a non-tangible material, the overall container can be considered malleable (where in the case of a tangible substance such as oil, the container cannot simply be enlarged). In some instances, the discrepancy can be referred to as an “overdraft.” In some instances, overdrafts can be agreed upon/approved (e.g., a maximum allowable overdraft without any penalty, etc.). Overdrafts can also be considered a special type of material, not one that tangible, but one that has value that can be treated as both negative (has an effect on something such as a bank account—results in a negative bank account balance) and a positive value (what is the actual amount of the overdraft itself). For example, where money is a non-tangible material, a cash deficit can actually be treated as a negative storage with a value (e.g., taking an absolute value will provide the positive value). As another example, if a company is allowed to withdraw no more than $200,000 over an existing balance from a bank account and the account only has $50,000, there would be a $150,000 discrepancy (overdraft) made. Here the overdraft has both a negative value (−$150,000 in relation to the bank account) and an overall value of $150,000. As a further example, a company is not willing to have more than $300,000 in any one bank from a risk perspective. Then, an allowed overdraft for $50,000 occurs on an account from a particular bank.

Depending on a point-of-view, an overdraft can be an issue with balancing, pooling, and/or portfolio management that needs to be accounted for in some manner (e.g., by agreements, clear establishment of definitions and/or boundary conditions). Technically the company is allowed to use $350,000 in the particular bank and from the point of view of a maximum fill level (e.g., 204 and 208b), the overdraft is positive and moves the fill “level” up $50,000, but from the point-of-view of the overall bank account balance, +$300,000 is all that is permissible to be stored in the bank account and $50,000 is treated as a negative balance. In some implementations, one way that an overdraft can be handled in a balance, pooling, and portfolio management situation is to consider it a temporary exception to a minimum/maximum fill level and to restrain it by time (1-2 days), amount (some particular boundary value), etc. It might also be necessary over a particular timeframe to account for a varying overdraft amount (e.g., such as when deposits are made to a bank account, etc.) or if a risk level changes on a bank and requires that a different bank be used (which might also cause an overdraft at the different bank) to help reduce an existing overdraft at the more “risky” bank.

Referring to FIG. 4, an energy provider with a contract 404 with a consumer 406 does not need to maintain all the energy that is needed on a continuous basis. The energy provider can have in a smart portfolio (with known pools of energy, maximum/minimum levels, where to put overproduction and how to rectify underproduction, with established buffers, etc.), accessible external systems that are either owned (e.g., power plants 408) or purchased using an energy broker 410. In deciding which to access at any point in time, the energy provider 402 can take into account values 412 such as spot market cost, intra-day cost, urgent cost, etc. Note that in some instances, a broker 414 can link the consumer 406 with the energy provider 402. Also, the power plants 408 can also contact a resource provider 416 (e.g., for natural gas, coal, nuclear material, etc. to run the power plant). The smart portfolio management can be used to satisfy the contract 404 with the customer.

Possible goals to be met when composing a portfolio can include, among other things:

Meeting market requirements

Optimizing profit

Satisfying customers

Meeting security/reliability requirements

Minimizing buffers

Ensuring basic service

Hedging

Controlling risks.

Constraints to consider when composing a portfolio can include, among other things:

Differing delays until a resource is available

Variability in ordered quantity depends on market type

Cost of procurements

Cost of production

Cost of Sales

Variability in available key figures/players in portfolio scenarios.

FIG. 5 is a high-level block diagram of an example distributed computing system (EDCS) for providing the above-described services related to FIGS. 1, 2A, 2B, 2C, and 3 according to an implementation. The illustrated EDCS 500 includes or is communicably coupled with a server 502 and a client 540 (e.g., a mobile or other device) that communicate across a network 530. In some implementations, one or more components of the EDCS 500 may be configured to operate within a cloud-computing-based environment.

At a high level, the server 502 is an electronic computing device operable to receive, transmit, process, store, or manage data and information associated with the EDCS 500. According to some implementations, the server 502 may also include or be communicably coupled with an e-mail server, a web server, a caching server, a streaming data server, a business intelligence (BI) server, and/or other server.

Specifically, the server 502 provides services/functionality for efficient storage of existing resources, services/functionality for efficient storage of existing resources by combining various storage media into a pool, and/or services/functionality for efficient purchase of existing resources by determining an optimum procurement portfolio (all described above). The server 502 is responsible for receiving, among other things, requests and content from one or more client applications 546 associated with the client 540 of the EDCS 500 and responding to the received requests. In some implementations, the server 502 processes the requests at least in the optimization engine 507. In addition to requests received from the client 540, requests may also be sent to the server 502 from internal users, external or third-parties, other automated applications, as well as any other appropriate entities, individuals, systems, or computers. In some implementations, various requests can be sent directly to server 502 from a user accessing server 502 directly (e.g., from a server command console or by other appropriate access method).

Each of the components of the server 502 can communicate using a system bus 503. In some implementations, any and/or all the components of the server 502, both hardware and/or software, may interface with each other and/or the interface 504 over the system bus 503 using an application programming interface (API) 512 and/or a service layer 513. The API 512 may include specifications for routines, data structures, and object classes. The API 512 may be either computer-language independent or dependent and refer to a complete interface, a single function, or even a set of APIs. The service layer 513 provides software services to the EDCS 500. The functionality of the server 502 may be accessible for all service consumers using this service layer. Software services, such as those provided by the service layer 513, provide reusable, defined business functionalities through a defined interface. For example, the interface may be software written in JAVA, C++, or other suitable language providing data in extensible markup language (XML) format or other suitable format. While illustrated as an integrated component of the server 502 in the EDCS 500, alternative implementations may illustrate the API 512 and/or the service layer 513 as stand-alone components in relation to other components of the EDCS 500. Moreover, any or all parts of the API 512 and/or the service layer 513 may be implemented as child or sub-modules of another software module, enterprise application, or hardware module without departing from the scope of this disclosure. For example, the API 512 could be integrated into the optimization engine 507.

The server 502 includes an interface 504. Although illustrated as a single interface 504 in FIG. 5, two or more interfaces 504 may be used according to particular needs, desires, or particular implementations of the EDCS 500. The interface 504 is used by the server 502 for communicating with other systems in a distributed environment—including within the EDCS 500—connected to the network 530; for example, the client 540 as well as other systems communicably coupled to the network 530 (whether illustrated or not). Generally, the interface 504 comprises logic encoded in software and/or hardware in a suitable combination and operable to communicate with the network 530. More specifically, the interface 504 may comprise software supporting one or more communication protocols associated with communications such that the network 530 or interface's hardware is operable to communicate physical signals within and outside of the illustrated EDCS 500.

The server 502 includes a processor 505. Although illustrated as a single processor 505 in FIG. 5, two or more processors may be used according to particular needs, desires, or particular implementations of the EDCS 500. Generally, the processor 505 executes instructions and manipulates data to perform the operations of the server 502. Specifically, the processor 505 executes the services/functionality for efficient storage of existing resources, the services/functionality for efficient storage of existing resources by combining various storage media into a pool, and/or the services/functionality for efficient purchase of existing resources by determining an optimum procurement portfolio.

The server 502 also includes a memory 506 that holds data for the server 502, client 540, and/or other components of the EDCS 500. Although illustrated as a single memory 506 in FIG. 5, two or more memories may be used according to particular needs, desires, or particular implementations of the EDCS 500. While memory 506 is illustrated as an integral component of the server 502, in alternative implementations, memory 506 can be external to the server 502 and/or the EDCS 500. In some implementations, memory 506 can be configured to store one or more instances of technical master data 520, customizing data 522, regulatory attributes/rules 524, demand planning data 526 (all described above), and/or other appropriate data.

The optimization engine 507 is any type of application/software that provides services/functionality for efficient storage of existing resources, the services/functionality for efficient storage of existing resources by combining various storage media into a pool, and/or the services/functionality for efficient purchase of existing resources by determining an optimum procurement portfolio. In some implementations, the optimization engine 507 can accept requests from a client 540 (e.g., the client application 546), receive data from a client 540, process the received data, and/or transmit data to the client 540. For example, the optimization engine 507 can receive a request to optimize overnight storage of funds to maximize returned interest. Those of skill in the art will appreciate that this example is only for illustrative purposes and many different requests and functionality can be received/performed by the optimization engine 507.

In some implementations, the optimization engine 507 can use dynamic optimization methods to perform its functionality. Optimization methods can be commercially available, proprietary, open source, etc. The optimization methods can be encapsulated within the optimization engine, called from a local and/or remote location, and/or dynamically generated by the optimization engine depending upon criteria/attributes such as material attributes, storage locations/types, and/or any data consistent with this disclosure. In some implementations, the optimization engine acts to “control” one or more optimization methods (e.g., optimization method interactions, data input/output, etc.).

Although illustrated as a single optimization engine 507, the optimization engine 507 may be implemented as multiple optimization engines 507. In addition, although illustrated as integral to the server 502, in alternative implementations, the optimization engine 507 can be external to the server 502 and/or the EDCS 500 (e.g., wholly or partially executing on the client 540, other server 502 (not illustrated), etc.).

Once a particular optimization engine 507 is launched, the particular optimization engine 507 can be used, for example by a client 540, other server 502, and/or other component of the EDCS 500 to interactively process a task, event, or other information/content associated with the server 502 and/or the client 540. In some implementations, the optimization engine 507 may be a network-based, web-based, and/or other suitable application consistent with this disclosure.

In some implementations, a particular optimization engine 507 may operate in response to and in connection with at least one request received from another optimization engine 507, other components (e.g., software and/or hardware modules) associated with another servers 502, and/or other components of the EDCS 500 (whether illustrated or not). In some implementations, the optimization engine 507 can be accessed and executed in a cloud-based computing environment using the network 530. In some implementations, a portion of a particular optimization engine 507 may be a web service associated with the optimization engine 507 that is remotely called, while another portion of the optimization engine 507 may be an interface object or agent bundled for processing by any suitable component of the EDCS 500. Moreover, any or all of a particular optimization engine 507 may be a child or sub-module of another software module or application (not illustrated) without departing from the scope of this disclosure. Still further, portions of the particular optimization engine 507 may be executed or accessed by a user working directly at the server 502, as well as remotely at a corresponding client 540. In some implementations, the server 502 or any suitable component of server 502 or the EDCS 500 can execute the optimization engine 507.

The client 540 may be any computing device operable to connect to or communicate with at least the server 502. In general, the client 540 comprises an electronic computing device operable to receive, transmit, process, and store any appropriate data associated with the EDCS 500, for example, the optimization engine 507, and the like. More particularly, among other things, the client 540 can collect content from the client 540 and upload the collected content to the server 502. The client typically includes a processor 544, a client application 546, a memory 548, and/or an interface 549 interfacing over a system bus 541.

The client application 546 is any type of application (e.g., a web browser and/or native application) that allows the client 540 to navigate to/from, request, view, create, edit, delete, administer, and/or manipulate content associated with the server 502. For example, the client application 546 can present GUI displays and associated data to a user generated by the optimization engine 507, accept user input, and transmit the user input back to the server 502 for dissemination to the appropriate components of server 502, in particular the optimization engine 507. In some implementations, the client application 546 can use parameters, metadata, and other information received at launch to access a particular set of data from the server 502 and/or other components of the EDCS 500. Once a particular client application 546 is launched, a user may interactively process a task, event, or other information associated with the server 502 and/or other components of the EDCS 500. In some implementations, the client 540/client application 546 can provide can provide, either wholly or in conjunction with the server 502, services/functionality for efficient storage of existing resources, services/functionality for efficient storage of existing resources by combining various storage media into a pool, and services/functionality for efficient purchase of existing resources by determining an optimum procurement portfolio.

In some implementations, the client application 546 can also be used perform administrative functions related to the optimization engine 507. For example, the optimization engine 507 can generate and transmit administrative pages to the client application 546 based on a particular user login.

Further, although illustrated as a single client application 546, the client application 546 may be implemented as multiple client applications in the client 540. For example, there may be a native client application and a web-based (e.g., HTML) client application, and the like depending upon the particular needs of the client 540.

The interface 549 is used by the client 540 for communicating with other computing systems in a distributed computing system environment, including within the EDCS 500, using network 530. For example, the client 540 uses the interface to communicate with a server 502 as well as other systems (not illustrated) that can be communicably coupled to the network 530. The interface 549 may be consistent with the above-described interface 504 of the server 502. The processor 544 may be consistent with the above-described processor 505 of the server 502. Specifically, the processor 544 executes instructions and manipulates data to perform the operations of the client 540, including the functionality required to send requests to the server 502 and to receive and process responses from the server 502. In some implementations, the processor 544 can execute instructions to provide the services/functionality for efficient storage of existing resources, the services/functionality for efficient storage of existing resources by combining various storage media into a pool, and/or the services/functionality for efficient purchase of existing resources by determining an optimum procurement portfolio

The memory 548 typically stores objects and/or data associated with the purposes of the client 540 but may also be consistent with the above-described memory 506 of the server 502 or other memories within the EDCS 500 and be used to store data similar to that stored in the other memories of the EDCS 500 for purposes such as backup, caching, and the like.

Further, the illustrated client 540 includes a GUI 542 that interfaces with at least a portion of the EDCS 500 for any suitable purpose. For example, the GUI 542 (illustrated as associated with client 540a) may be used to view data associated with the client 540, the server 502, or any other component of the EDCS 500. In particular, in some implementations, the client application 546 may act as a GUI interface for the optimization engine 507 and/or other components of server 502.

There may be any number of clients 540 associated with, or external to, the EDCS 500. For example, while the illustrated EDCS 500 includes one client 540 communicably coupled to the server 502 using network 530, alternative implementations of the EDCS 500 may include any number of clients 540 suitable to the purposes of the EDCS 500. Additionally, there may also be one or more additional clients 540 external to the illustrated portion of the EDCS 500 that are capable of interacting with the EDCS 500 using the network 530. Further, the term “client” and “user” may be used interchangeably as appropriate without departing from the scope of this disclosure. Moreover, while the client 540 is described in terms of being used by a single user, this disclosure contemplates that many users may use one computer, or that one user may use multiple computers.

The illustrated client 540 (example configurations illustrated as 540a-540c) is intended to encompass any computing device such as a desktop computer, laptop/notebook computer, wireless data port, smart phone, personal data assistant (PDA), tablet computing device, one or more processors within these devices, or any other suitable processing device. For example, the client 540 may comprise a computer that includes an input device, such as a keypad, touch screen, or other device that can accept user information, and an output device that conveys information associated with the operation of the server 502 or the client 540 itself, including digital data, visual and/or audio information, or a GUI 542, as illustrated specifically with respect to the client 540a.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The term “data processing apparatus,” “computer,” or “electronic computer device” (or equivalent as understood by one of ordinary skill in the art) refers to data processing hardware and encompasses all kinds of apparatus, devices, and machines for processing data, including by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, a FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically-erasable programmable read-only memory (EEPROM), and flash memory devices; magnetic disks, e.g., internal hard disks or removable disks; magneto-optical disks; and CD-ROM, DVD+/-R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), LED (Light Emitting Diode), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A computer-implemented method comprising:
building a data model enhanced for efficient storage of a material, the enhancements permitting generation of optimization problem solutions related to storage of the material, wherein the enhancements include technical specifications and customizing data;
enhancing one or more attributes of the enhanced data model with regulatory attributes or rules;
performing, using the enhanced data model, demand planning related to the material;
performing, using a dynamic optimization algorithm, material transfer planning to determine where to most effectively store the material;
performing a simulation of various storage possibilities of the material; and
balancing amounts of the material using results of the performed simulation by shifting quantities of the material to, from, or within a particular storage medium.

2. The method of claim 1, wherein the technical specifications include attributes of the material relevant for storage of the material, the technical attributes including attributes and boundary conditions associated with the particular storage medium to store the material, and customizing data includes business-oriented managerial attributes and boundary conditions for the particular storage medium.

3. The method of claim 1, wherein demand planning includes at least one of determining what material is planned to be stored, for what period of time, in what kind of storage media, at what maximum costs, or where the material is located.

4. The method of claim 1, further comprising factoring-in risk opportunity considerations, including at least one of resources that might not be available when needed, insufficient buffer sizes, losses occurring through surplus, or an oversized buffer.

5. The method of claim 1, wherein the balancing includes determining the optimal maximum fill level for the particular storage medium.

6. A computer-implemented method comprising:
building a data model enhanced for efficient storage of a material by dynamically or statically expanding storage of the material in combined various storage mediums as a pooled storage, wherein the enhancements include technical specifications and customizing data;
performing, using the enhanced data model, demand planning related to the material;
performing, using a dynamic optimization algorithm, material transfer planning to determine where to most effectively store the material into the pooled storage, the pooled storage including a plurality of storage mediums of the various storage mediums;
performing a simulation of various pooled storage possibilities for the material;
determining a pool landscape of the pooled storage based on results of the performing of the simulation; and
balancing amounts of the material using results of the performed simulation by shifting quantities of the material to, from, or within storage mediums of the various storage medium associated with the pooled storage of the determined pool landscape.

7. The method of claim 6, wherein the technical specifications include attributes of the material relevant for storage of the material, the technical attributes including attributes and boundary conditions associated with the particular storage medium to store the material including attributes particular to each storage medium of the particular storage medium that is part of a pooled storage, and customizing data includes business-oriented managerial attributes and boundary conditions for the particular storage medium.

8. The method of claim 6, wherein demand planning includes at least one of determining what material is planned to be stored, for what period of time, in what kind of storage medium, at what maximum costs, or where the material is located.

9. The method of claim 6, further comprising instructions to factor-in risk opportunity considerations, including at least one of resources that might not be available when needed, insufficient buffer sizes, losses occurring through surplus, or an oversized buffer.

10. The method of claim 6, wherein the balancing includes determining the optimal maximum fill level for the various storage mediums associated with the pooled storage of the determined pool landscape.

11. A non-transitory, computer-readable medium storing computer-readable instructions executable by a computer and operable to:
build a data model enhanced for efficient storage of a material, the enhancements permitting generation of optimization problem solutions related to storage of the material, wherein the enhancements include technical specifications and customizing data;
enhance one or more attributes of the enhanced data model with regulatory attributes or rules;
perform, using the enhanced data model, demand planning related to the material;
perform, using a dynamic optimization algorithm, material transfer planning to determine which particular storage medium to use to most effectively store the material;
perform a simulation of various storage possibilities of the material; and
balance amounts of the material using results of the performed simulation by shifting quantities of the material to, from, or within the particular storage medium.

12. The medium of claim 11, wherein the technical specifications include attributes of the material relevant for storage of the material, the technical attributes including attributes and boundary conditions associated with the particular storage medium to store the material, and customizing data includes business-oriented managerial attributes and boundary conditions for the particular storage medium.

13. The medium of claim 12, wherein demand planning includes at least one of determining what material is planned to be stored, for what period of time, in what kind of storage medium, at what maximum costs, or where the material is located.

14. The medium of claim 11, further comprising factoring-in risk opportunity considerations, including at least one of resources that might not be available when needed, insufficient buffer sizes, losses occurring through surplus, or an oversized buffer.

15. The medium of claim 11, wherein the balancing includes determining the optimal maximum fill level for the particular storage medium.

16. A non-transitory, computer-readable medium storing computer-readable instructions executable by a computer and operable to:
build a data model enhanced for efficient storage of a material by dynamically or statically expanding storage of the material in combined various storage mediums as a pooled storage, wherein the enhancements include technical specifications and customizing data;
perform, using the enhanced data model, demand planning related to the material;
perform, using a dynamic optimization algorithm, material transfer planning to determine where to most effectively store the material into the pooled storage, the pooled storage including a plurality of storage mediums of the various storage mediums;
perform a simulation of various pooled storage possibilities for the material;
determine a pool landscape of the pooled storage based on results of the performing of the simulation; and
balance amounts of the material using results of the performed simulation by shifting quantities of the material to, from, or within storage mediums of the various storage medium associated with the pooled storage of the determined pool landscape.

17. The medium of claim 16, wherein the technical specifications include attributes of the material relevant for storage of the material, the technical attributes including attributes and boundary conditions associated with the particular storage medium to store the material including attributes particular to each storage medium of the particular storage medium that is part of a pooled storage, and customizing data includes business-oriented managerial attributes and boundary conditions for the particular storage medium.

18. The medium of claim 16, wherein demand planning includes at least one of determining what material is planned to be stored, for what period of time, in what kind of storage medium, at what maximum costs, or where the material is located.

19. The medium of claim 16, further comprising instructions to factor-in risk opportunity considerations, including at least one of resources that might not be available when needed, insufficient buffer sizes, losses occurring through surplus, or an oversized buffer.

20. The medium of claim 16, wherein the balancing includes determining the optimal maximum fill level for the various storage mediums associated with the pooled storage of the determined pool landscape.
